(19) United States
(12) Patent Application Publication
(10) Pub. No.: US 2009/0228909 A1
(43) Pub. Date: Sep. 10, 2009

(54) MULTIMEDIA SYSTEM AND METHOD THEREOF

(76) Inventor: Yao-Chang Huang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/042,320

(22) Filed: Mar. 4, 2008

(51) Int. Cl. H04H 60/33

(52) U.S. Cl. 725/9

(57) ABSTRACT

A multimedia system includes a data information receiver, a storage device, and a processing unit. The data information receiver is for receiving data information related to input data received by the multimedia system. The storage device is for storing a first mode state parameter. The processing unit is for automatically switching the multimedia system from a second mode to a first mode according to the data information and the first mode state parameter after the multimedia system has been switched from the first mode to the second mode.

### BACKGROUND OF THE INVENTION

1. Field of the Invention

The present invention relates to a multimedia system and related methods, and particularly relates to a multimedia system that can automatically switch between operation modes, and related methods.

2. Description of the Prior Art

Conventionally, a TV system such as a digital TV (DTV) system always shows a “NO SIGNAL” warning message when the TV program quality is not good enough. The only option for a user is to wait until the signal quality improves in this situation.

If a TV system is integrated to a multimedia system, then a user can play audio/video, browse pictures, play games or use GPS navigation when the TV data signal quality is poor. However, the user does not know how the current TV data signal quality is and when to switch back to the TV program. The uncertainty does not matter when the program is not important to the user. But when the TV program is an important one, such as news or a sports game, the user will wish to return to it as soon as possible. It will make great inconvenient to repeatedly switch the system between two modes.

In addition, some portable TV systems, like personal video recorders (PVR), have recording functions for recording TV programs. The recorded data will be empty or consist of broken frames when the TV program quality is poor. Thus the recorded data is useless and wastes the storage capacity.

### SUMMARY OF THE INVENTION

Therefore, one objective of the present invention is to provide a multimedia system that can automatically switch operation modes so that a user does not need to switch operation modes manually and switches the system between systems to see if the signal quality is good or not.

Another objective of the present invention is to provide a portable TV system that can automatically switch operation modes, such that a user does not need to manually control the portable TV system to continue recording after the portable TV system stops recording due to poor signal quality.

One embodiment of the present invention discloses a multimedia system, which comprises a data information receiver, a storage device, and a processing unit. The data information receiver is for receiving data information related to input data received by the multimedia system. The storage device is for storing a first mode state parameter. The processing unit is for automatically switching the multimedia system from a second mode to a first mode according to the data information and the first mode state parameter after the multimedia system has been switched from the first mode to the second mode.

One embodiment of the present invention discloses a portable TV system, which can display or record TV data and comprises a data information receiver, a storage device, and a processing unit. The data information receiver is for receiving data information related to the TV data. The storage device is for storing recording state parameters. The processing unit is for controlling the portable TV system to continue recording the TV data according to the data information and the recording state parameters after the portable TV system stops recording the TV data.

Corresponding methods can be easily obtained via the above-mentioned embodiments, and thus are omitted for brevity.

According to the above-mentioned embodiments, users do not need to monitor whether the TV data signal quality improves or not, and the convenience of utilizing the system is thereby increased.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a multimedia system or a portable TV system according to embodiments of the present invention.

FIG. 2 is a flow chart illustrating a multimedia system controlling method or a TV data processing method according to embodiments of the present invention.

FIG. 3 is a schematic diagram illustrating the steps after the multimedia system is switched from the second mode to the first mode.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean, “include, but not limited to . . . ” Also, the term “couple” is intended to mean either an indirect or direct electrical connection. Accordingly, if one device is coupled to another device, that connection may be through a direct electrical connection, or through an indirect electrical connection via other devices and connections.

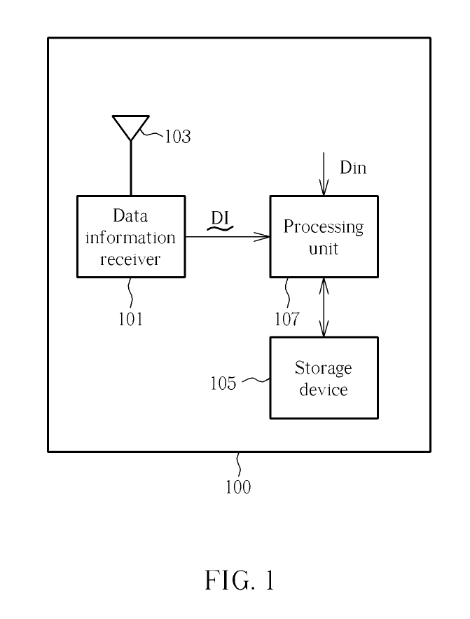

FIG. 1 is a block diagram illustrating a multimedia system or a portable TV system according to embodiments respectively of the present invention.

As shown in FIG. 1, the system 100 includes a data information receiver 101 coupled to an antenna 103 to receive a signal such as a data information signal, a storage device 105 and a processing unit 107. The data information receiver 101 is utilized for receiving data information DI related to input data Din received by the multimedia system. The storage device 105 is used for storing a first mode state parameter. It should be noted the input data Dᵢₙ and the data information DI can be received at a same path or at different paths.

Embodiment 1

In this embodiment, the system 100 is a portable multimedia system. The processing unit 107 automatically switches the multimedia system 100 from a first mode to a second mode according to the data information DI, which is a signal quality of the TV data, and controls the storage device 105 to store the first mode state parameter when the multimedia system is switched from a first mode to a second mode. The storage device further stores a threshold situation, and the processing unit 107 automatically switches the multimedia system from the first mode to the second mode according to whether the data information reaches the threshold situation. The threshold situation can be: the percentages of the signal quality, the fragment degree of the video, and the time-out value (that means if the signal quality is less than a predetermined value for a predetermined time). It should be noted that other kinds of threshold situation can also be used for determining the timing for switching.

Furthermore, the processing unit 107 can provide an interface (e.g. a user interface window) when the multimedia system is switched from a first mode to a second mode, such that the user can control the multimedia system 100 to selectively switch from the first mode to the second mode via the interface. Additionally, the user can further select the operation of the second mode via the interface.

In a preferred embodiment, the input data Dᵢₙ is TV data number, and the multimedia system displays the TV data in the first mode. The second mode can be operations other than displaying TV data, such as displaying movies/mp3, photo browsing, GPS navigation etc., and the first mode state parameter can be a channel number, a volume degree, and an EPG information, which are related with TV data. Thus the multimedia system can rapidly return to the original situation when the multimedia system is switched from the second mode to the first mode again.

After the multimedia system 100 is switched to the second mode manually or automatically, the processing unit 107 keeps monitoring the data information DI to see if the TV data can be displayed again, and controls the multimedia system 100 to switch back to the first mode when the processing unit 107 determines that the signal quality of the input data Din is good enough.

Embodiment 2

In another preferred embodiment, the input data Dᵢₙ is TV data and the multimedia system records the TV data in the first mode. In this case, when the multimedia system is switched from the first mode to the second mode, the recording operation stops and continues again when the multimedia system is switched from the second mode to the first mode again. In this embodiment, the first mode state parameter is selected from a group consisting of a recorded data length, a data recording quality, and a recording timing, which are related to recording operation.

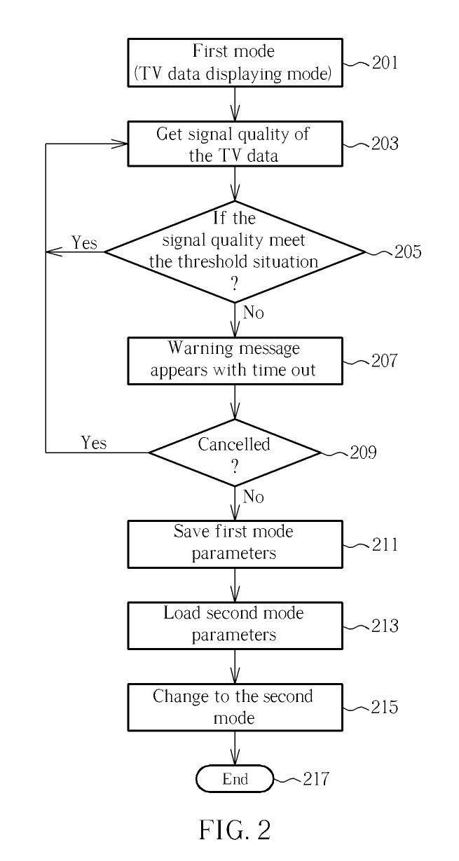

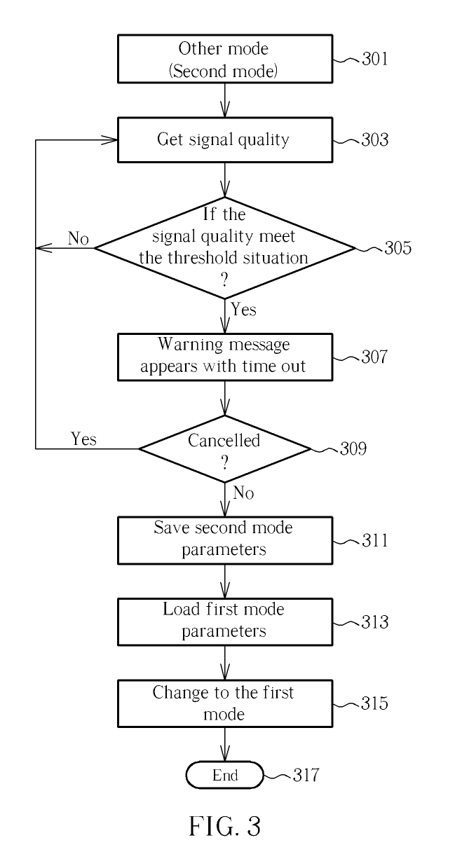

FIG. 2 and FIG. 3 are flow charts illustrating a multimedia system controlling method or a TV data processing method according to embodiments of the present invention. Via these diagrams, the operation of the system shown in FIG. 1 can be understood more clearly. It should be noted that these steps are only for example and do not meant to limit the scope of the present invention.

The steps shown in FIG. 2 include:

Step 201: the multimedia system operates in the first mode (TV data displaying mode);

Step 203: obtain signal quality of the TV data;

Step 205: check if the signal quality meets the threshold situation, if yes, go back to step 203, if not, go to step 207;

Step 207: warning message appears with time out, that is, a warning appears for a predetermined time period;

Step 209: ask the user if the switching operation should be cancelled, if yes, go back to step 203, if not, go to step 211;

Step 211: save first mode parameters;

Step 213: load second mode parameters, if any second mode parameters are recoded in the last switching operation;

Step 215: change to the second mode;

Step 217: end.

In this embodiment, step 205 indicates checking if the signal quality is good enough.

FIG. 3 is a schematic diagram illustrating the steps after the multimedia system is switched from the second mode to the first mode. The steps and rules shown in FIG. 2 are similar to the steps and rules shown in FIG. 3, and one difference is instep 305. If the signal is good enough, the steps after step 305 will be performed, and the multimedia system is switched to the first mode to display TV data again. Otherwise, if the signal is still poor, the multimedia system will keep monitoring the signal quality. Additionally, the step 311 saves second mode's parameters instead of first mode's parameters, the step 313 load first mode's parameters instead of second mode's parameters, and the step 315 changes to the first mode instead of the second mode.

As well known, a portable TV system is also a multimedia system, so the present invention also provides an invention for a portable TV system. If the system 100 is a portable TV system that can display and record TV data, the input data Din is TV data and each device of the system 100 has a similar operation with some small differences. The data information receiver 101 is used for receiving data information DI related to the TV data. The storage device 105 is used for storing recording state parameters. The processing unit 107 is used for controlling the portable TV system to stop recording according to the data information Din and for controlling the storage device to store the recording state parameters when the portable TV system stops recording. Also, the processing unit 107 can control the portable TV system to continue recording the TV data according to the data information DI and the recording state parameters after the portable TV system stops recording the TV data.

In this embodiment, the recording state parameters are selected from a group consisting of a recorded data length, a data recording quality, and a recording timing. Also, the data information Din can be a signal quality, the storage device 105 can further store a threshold situation, and the processing unit 107 controls the portable TV system according to whether the data information reaches the threshold situation.

Briefly, the portable TV system according to the present invention can automatically stop recording when the signal quality of TV data is poor, and continue recording when the signal quality improves and the recording operation is stopped, manually or automatically.

Methods corresponding to the above mentioned systems can be easily obtained by persons skilled in the art, and thus are omitted for brevity.

According to the above-mentioned systems and methods, a user does not need to switch the system between two modes to see if the signal is good or poor. Also, the portable TV system can automatically stop or continue recording according to the signal quality, thus the storage space can be saved and the convenience of use increased.

Those skilled in the art will readily observe that numerous modifications and alterations of the device and method may be made while retaining the teachings of the invention.

What is claimed is:

1. A multimedia system, comprising:
a data information receiver, for receiving data information related to input data received by the multimedia system;
a storage device, for storing a first mode state parameter; and
a processing unit, coupled to the storage device and the data information receiver, for automatically switching the multimedia system from a first mode to a second mode according to the data information, and for controlling the storage device to store the first mode state parameter when the multimedia system is switched from a first mode to a second mode.

2. The multimedia system of claim 1, wherein the processing unit further provides an interface according to the data information, to selectively control switching the multimedia system from the first mode to the second mode.

3. The multimedia system of claim 1, wherein the input data is TV data, and the multimedia system displays the TV data in the first mode.

4. The multimedia system of claim 3, wherein the first mode state parameter is at least one selected from a channel number, a volume degree, and an EPG information.

5. The multimedia system of claim 1, wherein the input data is TV data and the multimedia system records the TV data in the first mode, where the first mode state parameter is at least one selected from a recorded data length, a data recording quality, and a recording timing.

6. The multimedia system of claim 1, wherein the storage device further stores a threshold situation, and the processing unit automatically switches the multimedia system from the first mode to the second mode or provides the interface, according to whether the data information reaches the threshold situation.

7. The multimedia system of claim 1, wherein the data information is a signal quality of the input data.

8. A portable TV system, comprising:
a data information receiver, for receiving data information related to the TV data;
a storage device, for storing at least one recording state parameter; and
a processing unit, coupled to the data information receiver, for controlling the portable TV system to stop recording according to the data information and for controlling the storage device to store the recording state parameters when the portable TV system stops recording; or for controlling the portable TV system to continue recording the TV data according to the data information and the recording state parameters after the portable TV system stops recording the TV data.

9. The portable TV system of claim 8, wherein the recording state parameter is at least one selected from a recorded data length, a data recording quality, and a recording timing.

10. The portable TV system of claim 8, wherein the storage device further stores a threshold situation, and the processing unit controls the portable TV system according to whether the data information reaches the threshold situation.

11. The portable TV system of claim 8, wherein the data information is a signal quality of the TV data.

12. A controlling method for controlling a multimedia system, comprising:
(a) receiving data information related to input data received by the multimedia system;
(b) storing a first mode state parameter; and
(c) automatically switching the multimedia system from a first mode to a second mode according to the data information, and storing the first mode state parameter when the multimedia system is switched from a first mode to a second mode.

13. The controlling method of claim 12, wherein the step (c) further provides an interface according to the data information, to control selectively switching the multimedia system from the first mode to the second mode.

14. The controlling method of claim 12, wherein the input data is TV data, where the controlling method controls the multimedia system to display the TV data in the first mode.

15. The controlling method of claim 14, wherein the first mode state parameter is at least one selected from a channel number, a volume degree, and an EPG information.

16. The controlling method of claim 12, wherein the input data is TV data and the controlling method controls the multimedia system to record the TV data in the first mode, where the first mode state parameter is at least one selected from a recorded data length, a data recording quality, and a recording timing.

17. The controlling method of claim 12, wherein the step (b) further stores a threshold situation, and the step (c) is performed according to whether the data information reaches the threshold situation.

18. The controlling method of claim 12, wherein the data information is a signal quality of the input data.

19. A TV data processing method for a portable TV system, which can display or record TV data, comprising:
(a) receiving data information related to the TV data;
(b) storing recording state parameters; and
(c) controlling the portable TV system to stop recording according to the data information and for controlling the storage device to store the recording state parameters when the portable TV system stops recording, or for controlling the portable TV system to continue recording the TV data according to the data information and the recording state parameters after the portable TV system stops recording the TV data.

20. The TV data processing method of claim 19, wherein the recording state parameter is at least one selected from a recorded data length, a data recording quality, and a recording timing.

21. The TV data processing method of claim 19, wherein the step (b) further stores a threshold situation, and the step (c) controls the portable TV system to continue recording the TV data according to whether the data information reaches the threshold situation.

22. The TV data processing method of claim 19, wherein the data information is a signal quality of the TV data.
